(19) United States
(12) Patent Application Publication
(10) Pub. No.: US 2009/0035647 A1
(43) Pub. Date: Feb. 5, 2009

(54) Storage equipment and vehicle

(75) Inventor: Masaru Takagi, Toyota-shi (JP)

Correspondence Address: KENYON & KENYON LLP, 1500 K STREET N.W., SUITE 700, WASHINGTON, DC, 20005, US

(73) Assignee: TOYOTA JIDOSHA KABUSHIKI KAISHA, Toyota-shi (JP)

(21) Appl. No.: 12/213,765

(22) Filed: Jun. 24, 2008

(30) Foreign Application Priority Data
Jun. 27, 2007 (JP) 2007-168674

(51) Int. Cl. H01M 2/12

(52) U.S. Cl. 429/53

(57) ABSTRACT

A power storage apparatus is provided which has a simple structure, allows ready installation on a vehicle, and enables prevention of an outflow of a coolant when gas is discharged. The apparatus includes an assembled battery, a coolant which cools the assembled battery, a housing container (a battery housing case and a case cover) which houses the assembled battery and the coolant, a gas discharge port formed in the case cover and provided to release the pressure inside the battery housing case to the outside when gas produced in the assembled batter is discharged, an elastic container which communicates with the gas discharge port, and a coolant solidifying agent provided to solidify the coolant flowing into the elastic container from the housing container through the gas discharge port when the gas is discharged.

### BACKGROUND OF THE INVENTION

1. Field of the Invention

The present invention relates to a power storage apparatus including a power storage unit and a coolant for cooling the power storage unit in a housing container.

2. Description of the Related Art

Development of electrically powered vehicles such as electric cars and hybrid cars has been pursued vigorously in recent years. There is an increasing need for secondary batteries with excellent performance, reliability, and safety as driving or auxiliary power sources in the electrically powered vehicles.

These electrically powered vehicles require high power density of driving or auxiliary power sources. As one aspect, a power storage apparatus has been proposed which includes a housing container for housing an assembled battery formed of a plurality of electric cells connected in series and/or in parallel and a coolant for cooling the assembled battery.

Each electric cell has a gas discharge valve for discharging gas produced when a battery abnormality occurs. The gas discharge valve allows the release of the gas to prevent an extreme increase in internal pressure. The battery abnormality means a phenomenon in which an electrolyte is electrolyzed to produce gas, for example in overcharging.

Since the gas discharged from each electric cell increases the internal pressure of the housing container, the housing container needs to have high resistance to pressure. If the high resistance to pressure is provided by setting a large thickness dimension for the housing container, however, the housing container has an increased weight to result in the power storage apparatus having a larger size and a heavier weight.

Patent Document 1 has disclosed a battery in which an electrode element and an electrolyte are injected in a resin case. The resin case is provided with a gas discharge member for discharging gas. The gas discharge member has a gas discharge port connected to a gas discharge tube which guides gas to the outside.

It is contemplated that the gas discharge structure described in Patent Document 1 can be applied to the abovementioned power storage apparatus such that the gas discharge tube for discharging gas produced in a electric cell to the outside of the housing container is connected to the container.

[Patent Document 1] Japanese Patent Laid-Open No. 2005-71674

[Patent Document 2] Japanese Patent Laid-Open No. 11 (1999)-162433

[Patent Document 3] Japanese Patent Laid-Open No. 63 (1988)-98953

The provision of the gas discharge tube, however, complicates the structure of the power storage apparatus and violates the need for a smaller size and a lighter weight.

In addition, the gas discharge tube must be led to a position outside the interior of a vehicle (for example, a quarter trim) to avoid interference with any structure in the interior, which complicates the installation work of the power storage apparatus.

Furthermore, when the coolant is discharged from the gas discharge tube together with gas, extra work should be done to deal with the discharged coolant.

### SUMMARY OF THE INVENTION

It is an object of the present invention to provide a power storage apparatus which has a simple structure, allows ready installation on a vehicle, and enables prevention of an outflow of a coolant when gas is discharged.

To solve the abovementioned problem, according to an aspect, the present invention provides a power storage apparatus including a power storage unit, a coolant which cools the power storage unit, a housing container which houses the power storage unit and the coolant, a pressure release port which is formed in the housing container and is provided to release a pressure inside the housing container to the outside when gas produced in the power storage unit is discharged, a pressure release container which communicates with the pressure release port, and a solidifying agent which is provided to solidify the coolant flowing into the pressure release container from the housing container through the pressure release port when the gas is discharged.

The coolant may be formed of oil.

The pressure release container may be formed of an elastic container which can be expanded and contracted.

The pressure release port may be provided with a pressure release valve.

### BRIEF DESCRIPTION OF DRAWINGS

FIG. 1 is a section view showing a power storage apparatus according to an embodiment of the present invention before a battery abnormality occurs.

FIG. 2 is a section view showing a cylindrical electric cell.

FIG. 3 is a section view showing the power storage apparatus when a battery abnormality occurs.

FIG. 4 is a section view showing a power storage apparatus according to another embodiment.

### DESCRIPTION OF THE EMBODIMENTS

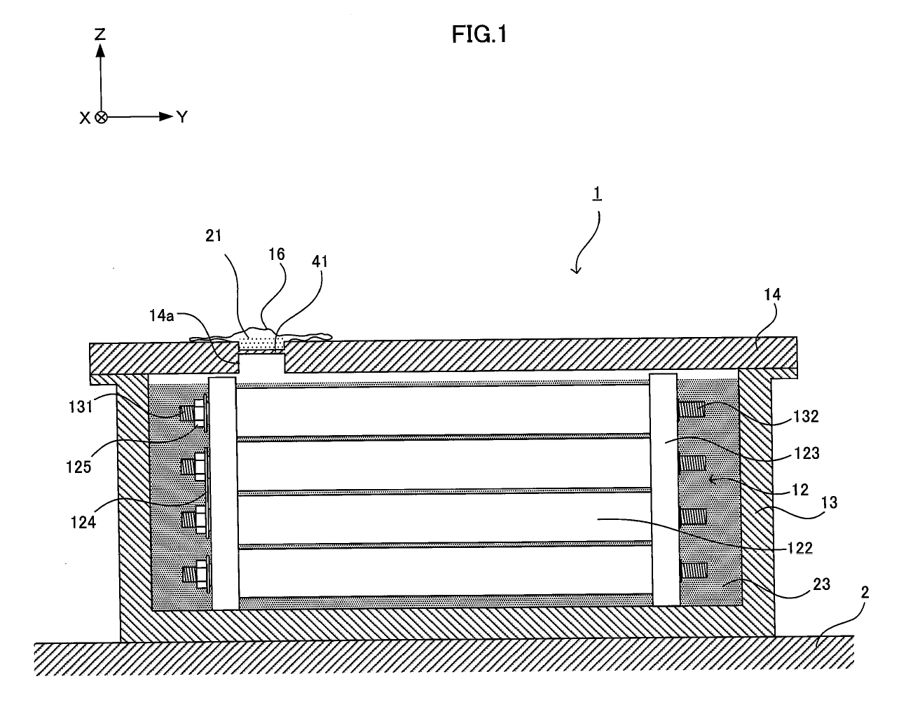

An embodiment of the present invention will hereinafter be described with reference to FIGS. 1 to 4.

FIG. 1 is a section view showing a power storage apparatus of the embodiment. In FIG. 1, a power storage apparatus 1 is formed of an assembled battery (power storage unit) 12 which includes a plurality of cylindrical electric cells 122 connected electrically, a battery holding case (housing container) 13 which accommodates the assembled battery 12 and a coolant 23, and a case cover (housing container) 14 which serves as an upper lid of the battery housing case 13. The power storage apparatus 1 is used as a driving or auxiliary power source of a hybrid car and an electric car. The power storage apparatus 1 of the embodiment is placed on a floor panel 2 under a passenger seat.

The power storage apparatus 1 of the embodiment is schematically structured as below. The case cover 14 has a gas discharge port (pressure release port) 14a formed therein. The gas discharge port 14a is provided with a rupture-type valve (pressure release valve) 41.

The gas discharge port 14a communicates with an elastic container (pressure release container) 16. The elastic container houses a coolant solidifying agent (solidifying agent) 21.

When gas is produced in the assembled battery 12 at the time of a battery abnormality such as overcharging in the structure described above, the pressure inside the battery housing case 13 (hereinafter referred to as the internal pressure) is increased. Then, when the internal pressure of the battery housing case 13 reaches the repture pressure of the rupture-type valve 41, the rupture-type valve 41 is broken to discharge the gas inside the battery housing case 13 through the gas discharge port 14a. The gas discharged through the gas discharge port 14a flows into and expands the elastic container 16.

The coolant 23 flows into the elastic container 16 together with the gas and is solidified by reaction with the coolant solidifying agent 21.

In this manner, the coolant 23 flows out of the battery housing case 13 and is solidified inside the elastic container 16 in the battery abnormality. This can prevent the coolant 23 from flowing out to the surroundings of the power storage apparatus 1.

In addition, since the gas discharge tube described in the section of the related art can be omitted, the power storage apparatus 1 can be reduced in size and weight.

Next, the structure of each member of the power storage apparatus 1 will be described in more detail.

### (Battery Housing Case 13)

The battery housing case 13 has a box shape opened upward and has a number of heat-radiating fins (not shown) on an outer surface thereof. Such a number of heat-radiating fins can increase the area in contact with outside air to promote heat radiation of the assembled battery 12.

The battery housing case 13 can be made of metal material such as stainless steel having a high thermal conductivity.

The battery housing case 13 is provided with an attachment bracket, not shown, on the outer surface thereof. The attachment bracket is fixed to the floor panel 2 under the passenger seat to allow fastening of the power storage apparatus 1.

### (Assembled Battery 12)

The assembled battery 12 is a set of electric cells including the plurality of cylindrical electric cells 122 placed in parallel and is supported by a pair of battery holders 123 placed opposite to each other. Electrode screw shafts 131 and 132 placed at both ends of the cylindrical electric cells 122 protrude from the battery holders 123 and are connected in series via a bus bar 124. The bus bar 124 is fixed by tightening a fastening nut 125 onto each of the electrode screw shafts 131 and 132.

When the set of electric cells including the plurality of cylindrical electric cells 122 placed in parallel in this manner are used for a driving or auxiliary power source of a vehicle, charge and discharge of the battery are repeated to produce more and more heat. Thus, only gas cooling with cooling wind may cool the battery 12 insufficiently. To address this, in the embodiment, the assembled battery 12 is cooled by placing the assembled battery 12 in the coolant 23 having a higher thermal conductivity than that of gas.

Suitable materials for the coolant 23 include one that has a high specific heat, a high thermal conductivity, and a high boiling point, does not corrode the battery holding case 13 or the assembled battery 12, and has resistance to thermal decomposition, air oxidation, and electrolysis. An electrical insulating liquid is desirable to prevent short-circuit between electrode terminals. Specifically, oil (for example, silicone oil) can be used.

As the coolant solidifying agent 21, it is possible to use sodium hydroxide, 12-hydroxy stearate, glycerin fatty acid ester, stearate soap, amino acid based gelling agent, polystyrene polyolefin block polymer, and benzylidene sorbitol.

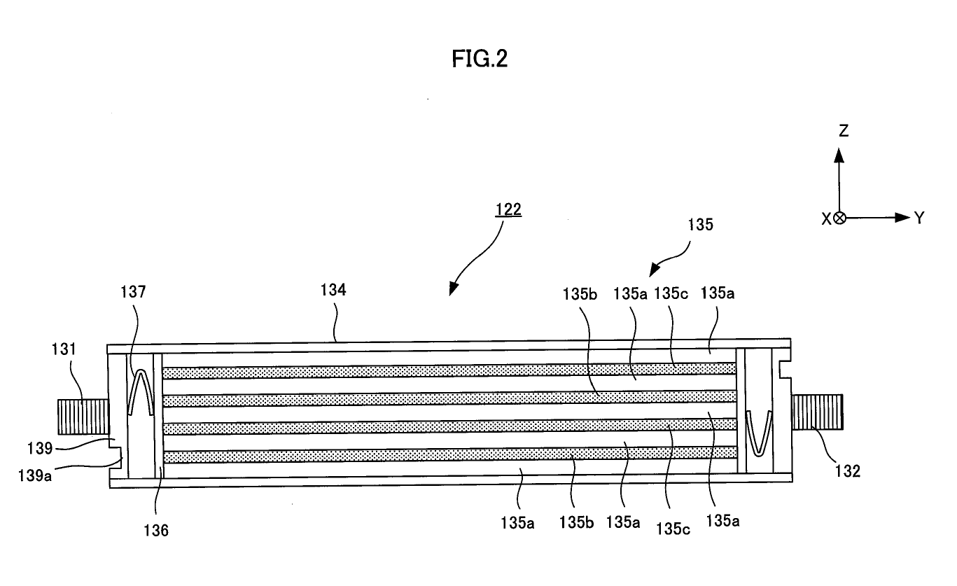

Next, the structure of each of the cylindrical electric cells 122 will be described in more detail with reference to FIG. 2. Electrode element 135 is housed inside a battery outer case 134 of a tubular shape.

The electrode element 135 is formed by spirally winding a strip-shaped positive electrode element 135b having a positive electrode active material applied to both surface thereof and a strip-shaped negative electrode element 135c having a negative electrode active material applied to both surface thereof with a separator 135a interposed between them. The battery outer case 134 contains an electrolyte injected therein. The electrolyte may be impregnated into the separator 135a.

Examples of the positive electrode active material may include LiCoO₂, LiNiO₂, LiFeO₂, LiCuO₂, LiMnO₂, LiMo₂ (M represents at least two of transition elements selected from the group consisting of Co, Ni, Fe, Cu, and Mn) , and LiMn₂O₄, all of which are lithium-transition element compound oxides. The negative electrode active material is not particularly limited as long as it may electrochemically occlude and emit lithium ions. Specific examples thereof may include natural graphite, artificial graphite, coke, organic burned body, and metal chalcogenides.

Examples of lithium salt used as a solute of the electrolyte may include LiClO₄, LiCF₃SO₃, LiPF₆, LiN (CF₃SO₂)₂, LiN (C₂F₅SO₂)₂, LiBF₄, LiSbF₆, and LiAsF₆. Examples of an organic solvent used for dissolving the lithium salt may include a mixture of a cyclic carbonate and a chain carbonate. Example of the cyclic carbonate may include ethylene carbonate, propylene carbonate, vinylene carbonate, and butylene carbonate. Example of the chain carbonate may include dimethyl carbonate, diethyl carbonate, and methyl ethyl carbonate.

A disc-shaped current collecting plate 136 is welded to each end of the electrode element 135 in a longitudinal direction (Y direction) of the cylindrical electric cell 122. The current collecting plate 136 may be made of aluminum foil, stainless steel foil, or copper foil, for example.

The current collecting plates 136 are electrically and mechanically connected through conducting wires 137 to holding plates 139 which hold the positive and negative electrode screw shafts 131 and 132. The holding plates 139 have rupture-type valves 139a at positions different from the positions where the positive and negative electrode screw shafts 131 and 132 are placed. The rupture-type valves 139a is formed by punching in the holding plate 139.

When gas is produced at the time of a battery abnormality to cause the internal pressure of the battery outer case 134 to exceed a limit pressure value (for example, two atmospheres), the rupture-type valves 139a are broken to discharge the gas to the outside of the cylindrical electric cell 122. This can prevent an extreme increase in internal pressure of the battery outer case 134. The battery abnormality means a phenomenon in which an electrolyte is electrolyzed to produce gas, for example in overcharging.

### (About Case Cover 14 and Elastic Container 16)

The gas discharge port 14a and the rupture-type valve 41 are formed by punching in the case cover 14. The gas discharge port 14a communicates with the elastic container 16. The elastic container 16 is connected to the case cover 14, and the connection can be achieved through welding or adhesion.

The working pressure of the rupture-type valve 41 is set to two atmospheres. The rupture-type valve 41 is broken when the internal pressure of the battery housing case 13 is increased to reach two atmospheres.

The elastic container 16 can be formed of nylon-6, 6. The elastic container 16 is preferably coated with chloroprene rubber or silicone rubber to provide heat resistance. This can prevent the elastic container 16 from melting by the heat of the gas flowing thereto from the battery housing case 13.

As shown in FIG. 1, the elastic container 16 is contracted before a battery abnormality occurs. This can reduce the size of the power storage apparatus 1 to facilitate the installation on a vehicle.

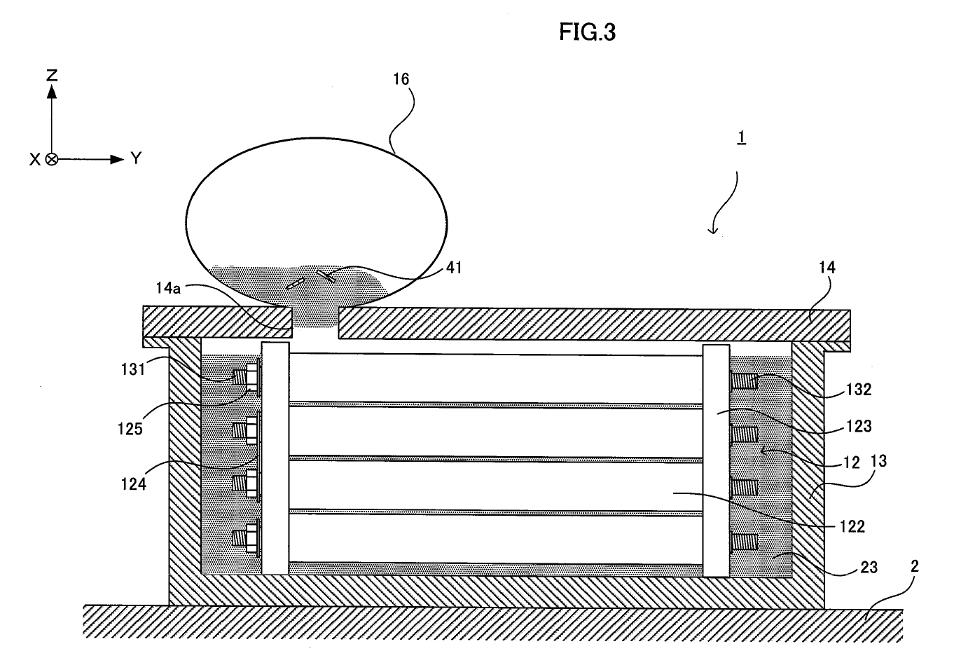

Next, the behavior of the power storage apparatus 1 when a battery abnormality occurs will be described with reference to FIGS. 1 and 3. FIG. 3 shows the power storage apparatus 1 at the time of the battery abnormality.

When the electrolyte in the cylindrical electric cell 122 is electrolyzed due to overcharging to produce gas which in turn increases the internal pressure of the cylindrical electric cell 122 to two atmospheres, the rupture-type valve 139a is broken.

After the rupture-type valve 139a is broken, the gas is discharged to the outside of the cylindrical electric cell 122, that is, into the coolant 23, to increase the internal pressure of the battery housing case 13. When the internal pressure of the battery housing case 13 is increased to two atmospheres, the rupture-type valve 41 is broken to discharge the gas and part of the coolant 23 through the gas discharge port 14a.

This can prevent an extreme increase in the internal pressure of the battery housing case 13. Since the increase in internal pressure of the battery housing case 13 can be prevented in this manner, the battery housing case 13 can be formed with low resistance to pressure. As a result, the power storage apparatus 1 can be reduced in size and weight.

The gas flows out through the gas discharge port 14a and then flows into and expands the elastic container 16 (see FIG. 3). The coolant 23 flows out through the gas discharge port 14a and then is solidified by reaction with the coolant solidifying agent 21.

The coolant 23 flowing out of the battery housing case 13 is caused to flow into the elastic container 16 in this manner, so that the coolant 23 can be prevented from flowing to a structure around the power storage apparatus 1 (for example, the floor panel 2). This can save the work of dealing with the coolant 23 flowing to the structure around the power storage apparatus 1.

In addition, the structure of the power storage apparatus 1 can be simplified and reduced in weight as compared with the method in which the gas is discharged to the outside of the vehicle through the gas discharge tube. Since the power storage apparatus 1 can be installed in the vehicle without having to take account of interference between the gas discharge tube and structures in the interior of the vehicle, the installation of the power storage apparatus 1 can be facilitated. The omission of the gas discharge tube also can reduce the cost of the power storage apparatus 1.

Furthermore, the coolant 23 can be prevented from flowing out onto roads.

The following effects can be obtained by solidifying the coolant 23 flowing into the elastic container 16. First, if the elastic container 16 is broken during replacement of the power storage apparatus 1 or the like (for example, if the elastic container 16 hits a vehicle structure and is broken), the coolant 23 can be prevent from flowing out. In addition, disassembly of the power storage apparatus 1 after the replacement can be facilitated.

### Other Embodiments

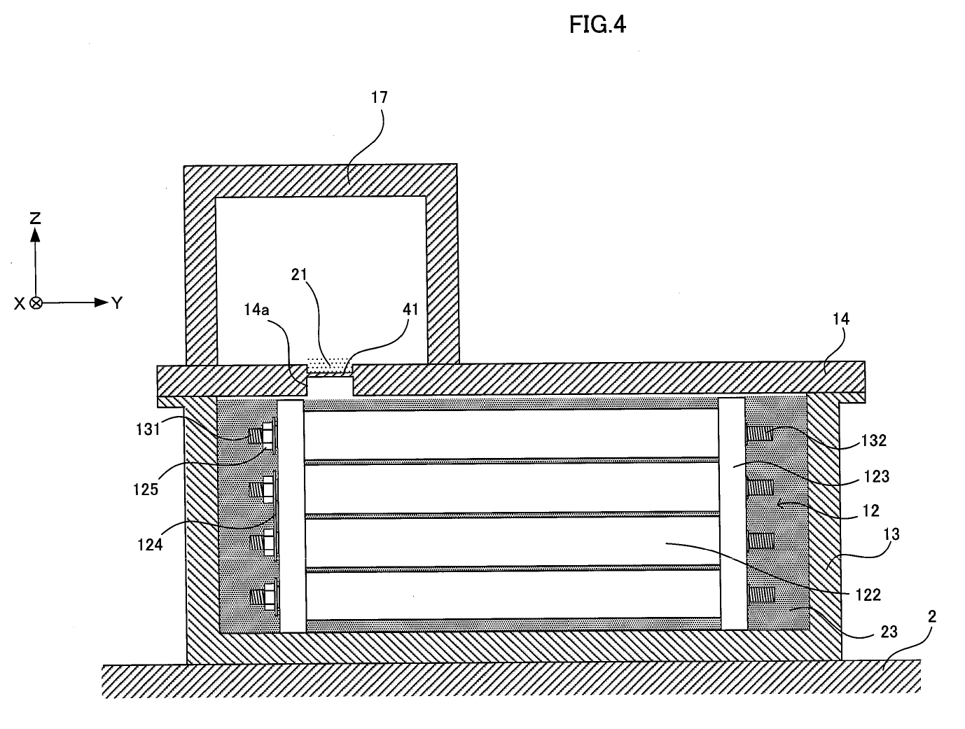

FIG. 4 is a section view showing a power storage apparatus according to another embodiment. As shown in FIG. 4, a robust container (pressure release container) 17 communicating with a gas discharge port 14a may be attached to a case cover 14. In this case, the effects similar to those in the embodiment described above can be provided.

While the abovementioned embodiment has described the cylindrical lithium ion battery, nickel metal hydride battery may be used or a square-type battery may be used. An electric double layer capacitor also may be used. The electric double layer capacitor includes a plurality of positive electrodes and negative electrodes stacked alternately with a separator interposed between them. In the electric double layer capacitor, for example, it is possible to use aluminum foil as a collector, activated carbon as a positive electrode active material and a negative electrode active material, and porous film made of polyethylene as the separator.

While the abovementioned embodiment has described the rupture-type valve 41 provided for the case cover 14, a different valve may be used such as a spring-type self-returning valve.

The power storage apparatus 1 may be placed under a backseat, in a trunk room or the like. The gas discharge port 14a may be formed in a side wall or a bottom wall of the battery housing case 13.

As described above, according to the present invention, the coolant flowing out of the housing container when gas is discharged can be solidified by the solidifying agent. This can prevent the coolant from flowing out to the outside.

1. A power storage apparatus comprising:
a power storage unit;
a coolant which cools the power storage unit;
a housing container which houses the power storage unit and the coolant;
a pressure release port which is formed in the housing container and is provided to release a pressure inside the housing container to the outside when gas produced in the power storage unit is discharged;
a pressure release container which communicates with the pressure release port; and
a solidifying agent which is provided to solidify the coolant flowing into the pressure release container from the housing container through the pressure release port when the gas is discharged.

2. The power storage apparatus according to claim 1, wherein the coolant comprises oil.

3. The power storage apparatus according to claim 1, wherein the pressure release container comprises an elastic container which can be expanded and contracted.

4. The power storage apparatus according to claim 1, wherein the pressure release port is provided with a pressure release valve.

5. A vehicle comprising the power storage apparatus according to claim 1.
